(19) United States
(12) Patent Application Publication
(10) Pub. No.: US 2025/0358247 A1
(43) Pub. Date: Nov. 20, 2025

(54) CONVERSATIONAL INTERACTION METHOD AND ELECTRONIC DEVICE BASED ON ARTIFICIAL INTELLIGENCE (AI) VIRTUAL CHARACTERS

(71) Applicant: ZHEJIANG TMALL TECHNOLOGY CO., LTD., Hangzhou (CN)

(72) Inventors: Siyuan DENG, Hangzhou (CN); He AI, Hangzhou (CN); Tianyu AN, Hangzhou (CN)

(21) Appl. No.: 19/069,952

(22) Filed: Mar. 4, 2025

(30) Foreign Application Priority Data
May 14, 2024 (CN) 202410599009.2

(51) Int. Cl. H04L 51/02; G06F 40/35; G06T 17/00; H04L 51/04

(52) U.S. Cl. CPC H04L 51/02; G06F 40/35; G06T 17/00; H04L 51/04

(57) ABSTRACT

A conversational interaction method comprises: responding to a request initiated by a user to initiate a multi-party conversation session, providing selectable AI virtual characters; after at least two AI virtual characters are selected, creating a multi-party conversation session, and adding the user and the at least two AI virtual characters as session members to the multi-party conversation session; during the conversation between a first AI virtual character and the user, semantically summarizing AI-generated response content from a perspective of the first AI virtual character to extract a core keyword; based on character setting tagging data and/or personality data of other AI virtual characters, determining whether there is a second AI virtual character whose characteristic matches the core keyword, and if such a character exists, generating conversational content from the perspective of the second AI virtual character that echoes the response content of the first AI virtual character.

### CROSS-REFERENCE TO RELATED APPLICATIONS

This application claims priority to Chinese Patent Application No. 202410599009.2, filed with the China National Intellectual Property Administration on May 14, 2024, and entitled “Conversational Interaction Method and Electronic Device Based on Artificial Intelligence (AI) Virtual Characters,” which is incorporated herein by reference in its entirety.

### TECHNICAL FIELD

The present application pertains to the field of AI interaction technology, specifically to a conversational interaction method and electronic device based on artificial intelligence (AI) virtual characters.

### BACKGROUND

In today's fast-paced and high-pressure society, especially among young people, the demands of daily work leave little time for social interactions. Consequently, many individuals lack social companions and have limited opportunities to express and discuss various issues, leading to a rising incidence of mental health disorders among the youth.

To address this situation, the market has introduced virtual emotional companion robots. These products offer users a variety of characters with different personalities and traits. Engaging in conversations with these characters yields diverse responses, providing rich language and emotional depth. Users can also share interesting conversation screenshots, enhancing the enjoyment of their interactions. Additionally, some platforms allow users to create custom characters for personalized conversations.

While these virtual emotional companion robots facilitate conversations with users, enhancing the effectiveness of these conversations to provide an experience akin to interacting with real humans remains a focal point for professionals in this field.

### SUMMARY

The present application provides a conversational interaction method and electronic device based on artificial intelligence (AI) virtual characters, enabling AI-driven chat conversations to closely resemble interactions with real individuals, thereby enhancing the user experience.

The invention provides the following solution:
a conversational interaction method based on AI virtual characters, comprising:
responding to a request initiated by a user to initiate a multi-party conversation session based on the AI virtual characters, providing selectable AI virtual characters;
after at least two AI virtual characters are selected, creating a multi-party conversation session, and adding the user and the at least two AI virtual characters as session members to the multi-party conversation session;
during the conversation between a first AI virtual character and the user, semantically summarizing AI-generated response content from a perspective of the first AI virtual character to extract a core keyword;
based on character setting tagging data and/or personality tagging data of other AI virtual characters, determining whether there is a second AI virtual character who's characteristic match the core keyword, and if such a character exists, generating conversational content from the perspective of the second AI virtual character that echoes the response content of the first AI virtual character; wherein the character setting tagging data includes setting words information used to describe the character setting of the AI virtual character.

In some embodiments, the method further includes:
during the multi-party conversation, intelligently arranging the AI virtual character based on user's intent and the character setting tagging data and/or personality tagging data of each AI virtual character, to determine which AI virtual character will engage in conversation with the user in each round of conversation;
wherein the intelligent arrangement includes: analyzing the intent of the user's input in a current round of conversation, and based on an intent analysis result, the character setting tagging data and/or personality tagging data corresponding to the at least two AI virtual characters, and contextual information generated during the conversation, matching the at least two AI virtual characters with the user's intent, and determining a target AI virtual character to engage in conversation with the user in the current round of conversation based on the matching results.

In some embodiments, the character data associated with the AI virtual characters includes the character setting tagging data and/or personality tagging data, and exemplary question-and-answer data that reflects expression habits of the AI virtual characters in conversation;
when generating the response content from the perspective of a specific AI virtual character, the response content is generated based on the character data of the AI virtual character, user data of the user, and semantic summary information of conversational context between the AI virtual character and the user.

In some embodiments, the selectable AI virtual characters include a system-predefined AI virtual character, a user-customized AI virtual character, and/or an AI virtual character created by a user with a creator identity within the system.

In some embodiments, the method further includes:
during a customization of the AI virtual character by a user or a creation of an AI virtual character by a user with a creator identity, assisting the user in generating the character data of the AI virtual character through an AI generation method.

In some embodiments, the method for assisting the user in generating the AI virtual character's character data through AI generation methods includes:
based on the character setting tagging data and/or the personality tagging data of the AI virtual character, generating a plurality of exemplary question data through the AI generation method, which reflect expression habits of the AI virtual character in conversation, and generating exemplary question-and-answer data after the user provides corresponding answer data for the question data, the exemplary question-and-answer data reflecting the expression habits of the AI virtual character in conversation, and the exemplary question-and-answer data is used to generate the response content when the corresponding AI virtual character replies.

In some embodiments, the method for assisting the user in generating the character data of the AI virtual character through an AI generation method includes:
based on text-based character data of the AI virtual character, generating image-based character data through the AI generation method, wherein the image-based character data includes an avatar and/or chat background image.

In some embodiments, the AI-generated response content from the AI virtual character includes multimodal response content;
before generating the response content from the perspective of the AI virtual character, determining a content type of the response content to be generated, so that the response content is generated by invoking an AI model with the corresponding content generation capability.

A conversational interaction method based on artificial intelligence (AI) virtual characters, comprises:
responding to a user-initiated request for script-based interaction using AI virtual characters, providing a collection of selectable scripts and a collection of selectable AI virtual characters, wherein the scripts are associated with a required number of characters, character setting tagging, and/or personality tagging, allowing the user to select corresponding AI virtual characters from the collection of AI virtual characters; the scripts are further associated with a plurality of key plot segments, and a plurality of keywords are configured in association with the key plot segments;
after a target script and target AI virtual character are selected, creating a script-based session and adding the user and the target AI virtual character to the session;
during the script-based session, checking the user's input for matches with the plurality of keywords, wherein, if a match is found, the plot advances to the next key plot segment; if the user's input does not match with the plurality of keywords, generating conversational content from the target AI virtual character that uses the keywords to guide a conversation into the next key plot segment.

In some embodiments, there is a maximum number of conversation rounds between adjacent key plot segments, wherein, if, as the maximum number of conversation rounds approaches, the user's input does not match the keywords, generating conversational content from the target AI virtual character that uses the keywords to guide the conversation into the next key plot segment.

A conversational interaction method based on artificial intelligence (AI) virtual characters, comprises:
responding to a user-initiated request for conversational interaction using AI virtual characters, providing selectable AI virtual characters;
after the AI virtual character is selected, creating a corresponding session and adding the user and the selected AI virtual character as members to the session;
during a conversation based on the session, generating prompt text based on a semantic summary information of conversational context in the session, user's information, and character data of the AI virtual character, and inputting the prompt text into the AI model, for the AI model to generate response content from a perspective of the AI virtual character; wherein the character data of a target AI virtual character includes: character setting tagging data, personality tagging data, and exemplary question-and-answer data that reflects expression habits of the AI virtual character in conversation, and the character setting tagging data includes: tagging words information used to describe the character setting of the AI virtual character.

In some embodiments, the AI-generated response content from the AI virtual character includes multimodal response content;
before generating the response content from the perspective of the AI virtual character, a type of content to be generated is determined, so that the AI model with the corresponding content generation capability is used to generate the response content.

A computer-readable storage medium storing a computer program, wherein, when executed by a processor, the program performs the steps of any of the methods described above.

An electronic device, comprising:
one or more processors; and
a memory associated with the one or more processors, the memory storing program instructions that, when read and executed by the one or more processors, perform the steps of any of the methods described above.

A computer program product, comprising a computer program/computer-executable instructions, wherein the computer program/computer-executable instructions, when executed by a processor in an electronic device, perform the steps of any of the methods described above.

According to the specific embodiments provided in this application, the following technical effects are disclosed:
through the first embodiment of the present application, in a multi-party conversation mode based on AI virtual characters, during the conversation between the first AI virtual character and the user, the AI-generated response content from the perspective of the first AI virtual character can be semantically summarized to obtain core keywords. Then, based on the character setting tagging data and/or personality tagging data of other AI virtual characters, it is determined whether there is a second AI virtual character whose characteristics match the core keywords. If such a character exists, conversational content from the perspective of the second AI virtual character can be generated to agree with the response content of the first AI virtual character. In this way, the multi-party conversation based on AI virtual characters is no longer a series of individual conversations between the virtual characters and the user. Instead, the virtual characters can “know” the conversational content of other virtual characters and interact with each other, making the multi-party conversation mode based on AI virtual characters closer to a real group chat scenario, thereby enhancing the user's experience.

Through the second embodiment of this application, in the “script chat” mode, both the script and the characters, as well as the plot, can adopt a loosely bound mode. Regarding the plot, key plot segments can be set, and keywords can be defined around these key plot segments. This allows the user, after a script is selected, to freely choose virtual characters from the character library. During the conversation, based on the user's conversational content, the system can check the match with the keywords to trigger the transition to the next key plot segment. If the user's conversation does not match the keywords, the system generates conversational content driven by the AI virtual character to guide the plot based on the keywords, prompting the user to say the keywords and advancing the plot to the next key plot segment. In this way, the user retains a certain level of conversational freedom while also maintaining the characteristic of progressing through the plot during the conversation in the script chat mode, thereby enhancing the user experience.

Through the third embodiment of this application, by adding the dimension of exemplary question-and-answer data in the character data of the AI virtual character, this exemplary question-and-answer data can reflect the expression habits of the AI virtual character during the conversation process, such as whether the character has certain catchphrases, etc. As a result, the AI virtual character can be portrayed in a fuller, more three-dimensional, and vivid manner. Specifically, during the conversation with the user, the generated conversational content is also richer, providing the user with an experience that is closer to interacting with a real person.

Additionally, the generated conversational content is not limited to text; it can also include voice, images, videos, and other multimodal forms of conversational content. Therefore, the conversational content is richer, further enhancing the realism of the interaction, making it more similar to conversing with a real person.

Certainly, implementing any product of this application does not necessarily require achieving all of the advantages described above simultaneously.

### BRIEF DESCRIPTION OF THE DRAWINGS

To better illustrate the technical solutions of the embodiments of this application or prior art, the following provides a brief description of the drawings used in the embodiments. It is apparent that the following drawings are just some of the embodiments of the present application, and those skilled in the art can, without inventive effort, derive other drawings based on these illustrations.

FIG. 1 is a schematic diagram of the system architecture provided in an embodiment of the present application;

FIG. 2 is a flowchart of the first method provided in an embodiment of the present application;

FIG. 3 is a flowchart of the second method provided in an embodiment of the present application;

FIG. 4 is a flowchart of the third method provided in an embodiment of the present application;

FIG. 5 is a schematic diagram of the electronic device provided in an embodiment of the present application.

### DETAIL DESCRIPTION OF THE EMBODIMENTS

The following will describe the technical solutions of the embodiments of this application in a clear and complete manner in conjunction with the accompanying drawings. It is evident that the described embodiments are only a part of the embodiments of this application, not all embodiments. Based on the embodiments in this application, all other embodiments that can be derived by those skilled in the art are within the scope of protection of this application.

In the embodiments of this application, the ability of AI (artificial intelligence) models can be leveraged to create various AI virtual characters for users by organizing and configuring prompt words. These virtual characters serve as companions during the user's leisure time, assisting with daily interactions, venting, and recording various daily matters. In the specific implementation, the product information service system can provide the above services. Additionally, by combining the mature product system, search, recommendation, and other capabilities of the product information service system, a related knowledge base can be introduced into the chat system. This allows the AI virtual character to assist the user in decision-making analysis, such as when the user needs a companion for shopping or recommendations. In summary, the solution provided in this application aims to offer a companion assistant in the product information service system that understands the user, accepts them unconditionally, knows what they want, and can help the user access products that meet their needs. The assistant can act as a listener and companion, providing the user with genuine emotional value. Certainly, in practical applications, these services can also be provided in other systems or offered as standalone apps (applications).

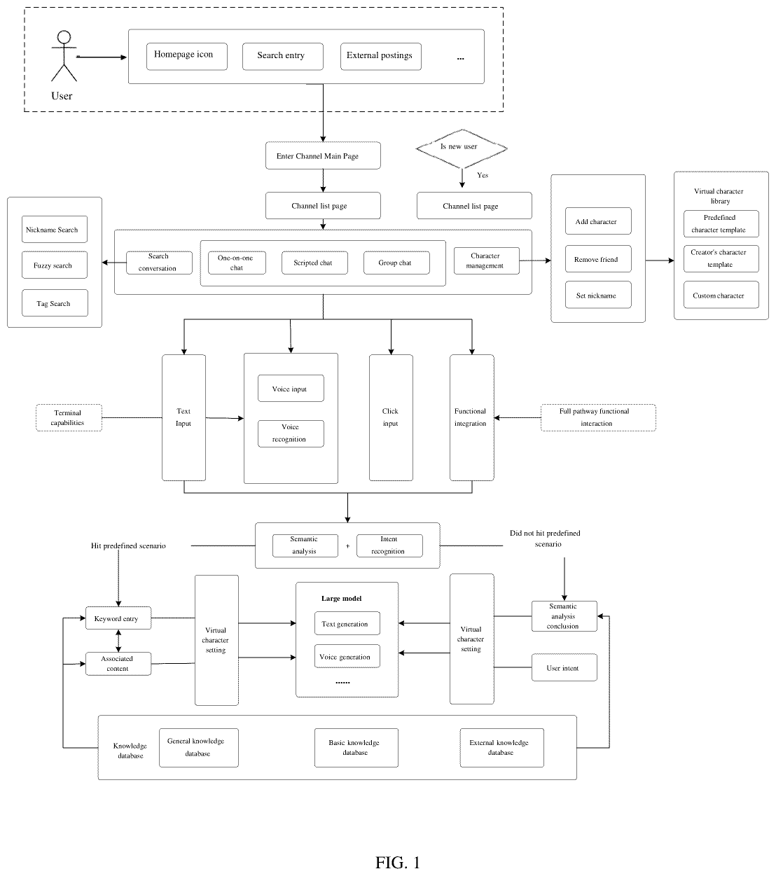

Specifically, referring to FIG. 1, the embodiments of this application provide a complete set of solutions for AI-based conversation. First, regarding the entry point for the AI virtual character-based conversation service, it can be provided in various ways. For example, if the service is in the form of a standalone app, users can access the corresponding service interface immediately upon launching the app. If the service is provided within another system, a relevant access entry can be provided within the system interface, or it can be deployed both internally and externally, etc. For instance, when the service is provided in a product information service system, it may include entry points such as homepage icons, a “search dome” (for example, accessing the service by typing keywords like “AI chat” in the search bar), “my” cards, etc. As for internal and external deployments, within the system, the service can exist as a full-link touchpoint, appearing in information streams, product detail pages, product review sections, shopping carts, and within various product interfaces. Externally, it can be deployed across a plurality of related apps, disseminated through a plurality of apps, and so on.

In this context, on pages such as the “my” card, the aforementioned entry points can exist in a permanent form, serving as important revisit paths. The “homepage icon” can be an entry that the user adds themselves, and the “search dome” can be an entry for users searching for products or those influenced by recommendations. In the case of internal deployment, target user segmentation can be achieved through operational strategies, with matched positions (such as in information streams, product detail pages, review sections, and shopping carts), as well as entry point exposure. In external deployment, various materials generated in bulk through advertising campaigns can be deployed into a plurality of external apps, serving as a means to drive traffic from outside the platform.

In summary, users can initiate specific chat requests through various different channels. In cases where requests are initiated from different source channels, AI can offer different greeting styles based on the user's possible needs. Additionally, depending on whether the user is using the feature for the first time, the greeting method can also vary. For instance, if the request is initiated from the homepage, it typically represents an exploratory function discovery. In this case, if the user is a “new user,” the greeting could start with something like “Haha, you found me!” followed by a new user guide animation, a self-introduction, a feature introduction, and an explanation of the revisit mechanism (since the homepage entry may not be permanent, the user might not be able to find it the next time they open the homepage, so the system can inform the user where to find it next time, etc.). If the user enters through the “my” card, as the “my” page is typically a personal homepage showcasing information related to the user, such as “my orders,” “my benefits,” etc., the greeting could be something like “Welcome home!” to align with the personal and familiar nature of the page. Furthermore, if the user enters from a product detail page, the user may have certain questions about that product. Therefore, the greeting could be related to the product, for example, “Would you like me to help explain this product?” and so on.

After completing the greeting and feature introduction, various optional chat modes can be offered to the user, such as one-on-one chat, group chat, script-based chat, and so on. Once the user selects a specific chat mode, they can proceed to choose an AI virtual character and engage in a chat conversation with the selected AI virtual character.

In specific implementation, an AI virtual character library can be provided, with a variety of selectable AI virtual characters. For example, one type of character may be pre-set by the platform, and these characters can be created based on predefined templates for shared use by all users. Another type may be user-customized virtual characters, where users can add character setting tagging, personality tagging, etc., to create more personalized virtual characters. Additionally, to further enrich the virtual character library, the embodiments of this application may support users taking on the character of creators and participating in the production of AI virtual characters. Specifically, users can register as creators, and the AI virtual characters created by these creators can be made available for other users to use. Based on factors such as the number of users and their evaluations of the AI virtual characters, creators may receive commissions, etc.

In the embodiments of this application, specific virtual characters can be expressed not only through combinations of various character setting tagging (such as gender, age, occupation, hobbies, etc.) and personality tagging (e.g., gentle, quiet, emotional, empathetic, etc.), but also through other richer dimensions to depict the virtual character's image in a more three-dimensional and complete manner. Specifically, as the virtual characters in this application are mainly used for conversation with users, these richer dimensions may include exemplary question-and-answer data that reflect the expression habits of the AI virtual character in conversation. In other words, when creating a virtual character, some exemplary questions can be provided. For example, an exemplary question could be, “What would you do if your friend lied to you?” The creator (whether it be platform operators, users with creator identities, or ordinary users) can answer from the perspective of the virtual character, using the virtual character's tone and style. Through different responses, the character's expression habits in communication can be reflected. These exemplary question-and-answer data can then be stored as part of the virtual character's character data in the virtual character library. This enables the creation of conversational content that reflects the virtual character's tone when responding during conversations with users. Through this method, even for virtual characters with similar character and personality tagging, differences in their expression habits during real conversations can highlight the distinctions between them. For virtual characters, their images become more three-dimensional and complete. They are no longer simply categorized into certain types based on combinations of settings (even if these categories are numerous); rather, they can also display differences based on how they express themselves in conversations. This provides a richer and more diverse virtual character image that better meets the conversational needs of users with a wide variety of emotional states and personalities.

Regarding the aforementioned exemplary questions, they can be some pre-set questions in the system or questions that are custom-created by the user, who can answer them in the tone of the virtual character they created, forming the exemplary question-and-answer data. Alternatively, the exemplary questions can be generated through AI. For example, when a creator is designing a virtual character, they may first select some character tagging or personality tagging. Then, using AI generation, the system can generate some exemplary questions based on these character setting tagging and personality tagging. In other words, for the AI model, when it is known that a virtual character has certain character or personality tagging, the model can design some questions based on these tagging, and the creator user can then respond. Specifically, this can be implemented by training the AI model in advance, allowing it to acquire the ability to generate questions based on the character setting tagging or personality tagging of different virtual characters. In this way, the AI model knows which questions to ask virtual characters with different character settings or personalities to reflect their expression habits in conversation.

Additionally, regarding the character data of the virtual characters, in addition to the aforementioned character setting tagging, personality tagging, and exemplary question-and-answer data expressed through text, it can also include image-based data. This image-based data can be used as the virtual character's avatar or as the background image for the chat window, among other possibilities. In specific implementation, this image-based data can be uploaded by the creator, or in the embodiments of this application, it can also be generated through AI. For example, after determining the character setting tagging, personality tagging, and exemplary question-and-answer data for a virtual character, an AI model capable of generating images from text can be used to generate an avatar for the corresponding virtual character. Alternatively, it could generate background images for the chat window, and so on.

After determining the character data of the virtual character, it can be saved to the virtual character library. Later, when a specific virtual character needs to engage in a conversation with the user, this character data can be input into the AI model. This allows the AI model to generate conversational content in the tone of that virtual character, including generating response content to reply to the user's conversation, and so on.

It should be noted that in the embodiments of this application, users can manage characters based on the virtual character library. For example, they can select certain virtual characters from the library to add as friends, remove friends, set nicknames for friends, and so on.

When the user needs to chat with an AI virtual character, a new chat session can be created. At this point, the user can choose a specific chat mode, such as one-on-one chat, group chat, script-based chat, and so on. Alternatively, the user can continue chatting based on previously created sessions. The system also supports session search, allowing the user to search for sessions by nickname or by tag. Fuzzy search is also supported, such as searching based on certain conversational content, and so on. Once a session is found, the user can continue chatting with the AI virtual characters already added in that session.

During the chat process, users can input content through text, voice, and other methods. The system can provide capabilities for text input, voice input, voice recognition, and other end-user features. Additionally, the system can support click-based inputs, such as clicking on product information, and so on. Furthermore, the system can offer functional integration capabilities. This capability is especially relevant when a system provides AI chat features, allowing some functions from that system to be integrated into the AI chat process, including various functionalities across the full product information service system. For example, through a product detail page overlay, an “AI assistant” can be provided, which the user can click to analyze and compare other products they have viewed or added to their cart. Additionally, capabilities that guide and help users make decisions can be exposed, such as “I can help you review a summary of the user feedback on this product,” and so on. Another feature could be a “store bundle assistant,” which helps users optimize their shopping by selecting and bundling large store coupons, allowing them to buy the most suitable and best items at the best price.

Whether it is one-on-one chat, group chat, or script-based chat, the system can generate conversational content in the tone of a specific virtual character through AI generation. The specific data input into the AI model may include the character data of the virtual character (including the aforementioned character setting tagging, personality tagging, exemplary question-and-answer data, etc.), as well as user information, including the user's personalities, and more. Additionally, the input can also include contextual information generated within the current chat session. Since AI models typically have limitations on the length of input information, the contextual information can be semantically summarized, and the keywords or other summarized information can be used to represent the context, which is then input into the AI model.

Additionally, in the embodiments of this application, the specific AI-generated conversational content may include multimodal elements. That is, the AI-generated conversational content is not limited to text; it can also include images, voice, and other modalities. In practice, based on the contextual information of the conversation, the appropriate modality for the reply can be determined. Correspondingly, an AI model with the capability to generate content in the selected modality can be invoked to generate the content.

For content of the same modality, there may be a plurality of AI models that each have corresponding generation capabilities. In specific implementations, these AI models can be selected. Alternatively, different AI models can be used to generate content of the same modality. A feedback mechanism can also be provided, allowing for optimization and adjustment of the AI models' performance scores based on user satisfaction with the conversational content, and other factors.

It should be noted that in specific implementations, to support the generation of conversational content during the AI chat process, knowledge bases can also be provided. These knowledge bases may include general knowledge bases, as well as external knowledge bases. Additionally, they may include proprietary knowledge bases related to specific systems. For example, when AI chat functionality is provided within a product information service system, a product information knowledge base within that system can be offered. The information in these knowledge bases can be provided to the AI model in a format supported by the model, to assist in generating conversational content.

The above provides a detailed introduction to the foundational capabilities for AI-based chat in the embodiments of this application, including the sources of virtual characters, the specific dimensions used to define virtual characters, and the AI generation of multimodal conversational content. As mentioned earlier, in the embodiments of this application, various chat modes can exist, including one-on-one chat, group chat, and script-based chat. Specifically, after determining the chat mode, the user can select a specific virtual character from the aforementioned virtual character library to engage in a conversation. For example, if the selected mode is one-on-one chat, where the user chats with a single virtual character, the user can choose a virtual character from the virtual character library, and the system will then create a chat session between the user and the selected virtual character. If it is a group chat, a plurality of virtual characters can be selected to join the group chat session. If it is a script-based chat, a script and virtual characters can be chosen, and the conversation will proceed according to the plot defined by the script. For group chat and script-based chat modes, in addition to the previously mentioned features such as the expression methods of virtual characters during the definition process and the generation of multimodal content, the embodiments of this application also provide other targeted improvements, which will be introduced separately below.

Firstly, regarding the group chat mode, as the name suggests, group chat involves a plurality of people chatting together. In the embodiments of this application, “a plurality of people” may include the user and a plurality of AI virtual characters, meaning the user can select a plurality of AI virtual characters to form a group, with each member being able to speak within the group. During the implementation of this application, the inventors discovered that while existing technologies also offer AI-based group chat modes, a key issue arises. Specifically, in existing systems, the AI virtual character who responds to the user in each round of the conversation is typically chosen randomly. As a result, it often leads to issues where the content of the responses from AI virtual characters does not align well with the context of the user's input. Additionally, different AI virtual characters in the group chat are not aware of each other's conversational content. While the format may appear as a group chat, in practice, it functions more like a plurality of AI virtual characters having individual one-on-one conversations with the user within the same session, making it difficult to effectively replicate a real group chat scenario.

To address the issues present in the group chat scenario, the embodiments of this application propose a solution. In the process where one virtual character (referred to as virtual character A) is having a conversation with the user, the AI-generated conversational content in the tone of virtual character A can be semantically summarized. This summary may include semantic keywords and other relevant information. The semantic keywords are then matched with the character data of other virtual characters in the same group chat session (primarily using character setting tagging, personality tagging, etc.). If there is a matching virtual character (such as virtual character B), the system can generate conversational content from virtual character B that echoes the previous response content of virtual character A. For example, if the user says something like “I like to wear a certain brand of shoes when I play basketball,” and virtual character A replies, “I like wearing a certain brand of shoes when I play basketball” (with the reply content generated by AI), and if virtual character B in the group chat has the “basketball enthusiast” character setting tagging, then the system can generate a reply from virtual character B that echoes virtual character A's content, such as “Me too!” or similar. This approach allows the virtual characters to be aware of each other's conversational content, making it so that the virtual characters no longer engage in isolated conversations with the user. Instead, they can interact with each other, enriching the conversation and bringing it closer to a real group chat scenario.

Additionally, regarding which specific virtual character will reply to the user's conversational content, intelligent arrangement can be implemented rather than relying on random selection of virtual characters. Specifically, during the group chat conversation, the system can identify the user's intent based on the content of their input. After identifying the user's intent, the system can match the AI virtual characters in the current group chat session with the user's intent, using the character setting tagging data and/or personality tagging data of each AI virtual character, as well as the contextual information generated during the conversation. Then, based on the matching results, the system can determine the target AI virtual character to engage in the conversation with the user in the current round of conversation.

In other words, in the embodiments of this application, which specific AI virtual character will respond to the user can be determined based on the contextual information and the matching results between the virtual character's and the user's intent, rather than being randomly selected. For example, in the previous scenario, suppose virtual character A was having a conversation with the user, and during the conversation, virtual character B agreed with virtual character A′s statement. After that, whether virtual character A will continue the conversation with the user or whether virtual character B will take over, can be determined by analyzing the intent of the user's next input and matching it with each virtual character.

Regarding the script-based chat mode, the inventors of this application have found that in existing implementations, the typical approach is for the platform to provide a fixed script, where the script includes different personas of intelligent agents (virtual characters). Users interact in real time with these AI-generated “intelligent agents,” creating emotional connections. However, after the user selects a script, the characters within the script are fixed, and all conversation is based on the predefined script. The conversation content is essentially limited to the script's content. Even if the user's input slightly deviates from the script during the conversation, the “intelligent agent” will immediately guide the conversation back to the script's content. In this approach, the script and characters are strongly bound, and the user's conversation is highly constrained, following the script's storyline closely. This limits the freedom of the user in terms of both the conversation partner and the content of the conversation. Furthermore, during the conversation, the virtual character can only generate text content, and cannot produce other modalities of conversational content.

In the embodiments of this application, based on the AI-driven conversational capabilities, further improvements have been made specifically for the script-based chat mode. Specifically, the script can still be created in advance, generating a script library, but in the embodiments of this application, the script adopts a KeyPlot (i.e., key frame) mode. That is to say, theoretically, a script cannot lose any frames while telling a story, or else the story might become incomplete. The characters in the script are typically fixed, and for this reason, in existing technologies, the script and characters are strongly bound, and the development of the plot must strictly follow the script's predefined settings.

In the key frame mode of the embodiments of this application, during the script creation process, a weak character setting and weak plot development approach can be used. Specifically, for the characters, only the number of required characters is set, or the necessary character setting tagging and personality tagging are simply configured. For the plot, only the central idea of the script and some discrete key plot segments are provided. During the user's selection of a script for chatting, the user can first choose a script. Then, based on the number of characters set in the script, along with the character setting tagging and personality tagging, the user can select the corresponding number of virtual characters with matching settings from the virtual character library to add to the current script-based chat session. In other words, the selection of the script and the selection of characters can be done separately. The script may only define the number of characters and some basic character settings, while the user can select which virtual character will play a specific character in the script. This allows greater freedom in selecting conversation partners. Once the script-based chat session is set up, the user can follow the predefined direction and plot of the script or choose to guide the plot's development according to their own preferences. Additionally, open-ended conclusions can be provided, allowing for even more flexibility in the storytelling process.

To allow for more flexible ways to trigger the next key plot segment, a plurality of keywords can be configured around each key plot segment. These keywords can be used to trigger the transition to the corresponding key plot segment. In other words, during the conversation, if the user's conversational content matches one of these keywords, it can directly trigger the transition to the corresponding key plot segment, rather than relying solely on the virtual character to guide the conversation. However, because the user's freedom in the conversation is relatively high, there may be cases where the user's conversation does not match any keyword. To address this, a maximum number of conversation rounds can be set between adjacent key plot segments, for example, 100 rounds. If, as the maximum number of conversation rounds approaches, the user's conversation still does not match any keywords, the system can generate conversational content from the target AI virtual character to guide the user into the next key plot segment based on the keywords. In other words, the user is given the priority to trigger the next key plot segment themselves, and if, after many rounds of conversation, they have not triggered it, the virtual character can guide the user into the next key plot segment. This way, the user retains a certain degree of freedom in the conversation, while also maintaining the characteristic of scripted conversation development in the script-based chat mode.

Based on the above, this application provides a plurality of specific embodiments from different perspectives, which will be introduced separately below.

### Embodiment 1

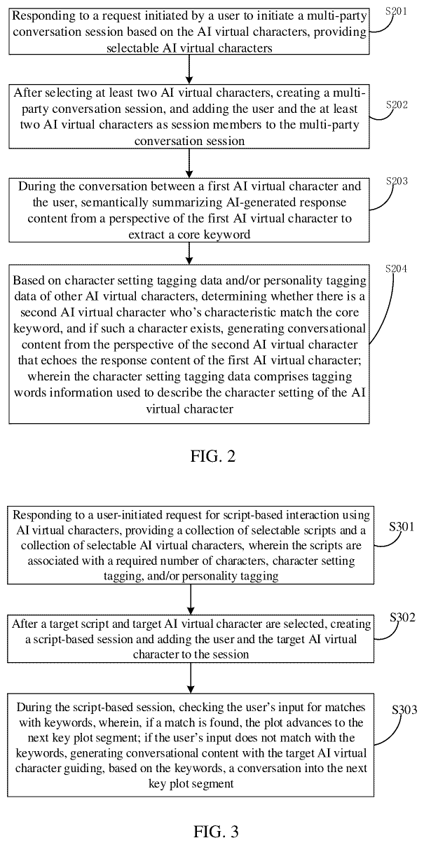

Firstly, this embodiment addresses the solution provided for the group chat mode and presents an AI virtual character-based group chat interaction method. Refer to FIG. 2. The method may include:

S201: responding to a request initiated by a user to initiate a multi-party conversation session based on the AI virtual characters, providing selectable AI virtual characters.

The AI virtual characters may include those pre-stored in the virtual character library, such as platform-predefined virtual characters, user-customized virtual characters, virtual characters created by other creator users, and so on. Users can select the characters based on their needs. During the selection process, information such as the character setting tagging and personality tagging of each virtual character can be displayed, allowing the user to make their choice based on this information.

S202: after at least two AI virtual characters are selected, creating a multi-party conversation session, and adding the user and the at least two AI virtual characters as session members to the multi-party conversation session.

After the AI virtual characters are selected, a corresponding conversation can be created. The current user and the at least two AI virtual characters selected by the user can be added as members to the multi-party conversation (i.e., group chat) to initiate the specific group chat mode.

S203: during the conversation between a first AI virtual character and the user, semantically summarizing AI-generated response content from a perspective of the first AI virtual character to extract a core keyword.

S204: based on character setting tagging data and/or personality tagging data of other AI virtual characters, determining whether there is a second AI virtual character who's characteristic match the core keyword, and if such a character exists, generating conversational content from the perspective of the second AI virtual character that echoes the response content of the first AI virtual character; wherein the character setting tagging data comprises tagging words information used to describe the character setting of the AI virtual character; wherein the character setting tagging data comprises tagging words information used to describe the character setting of the AI virtual character.

During the multi-party conversation, intelligent arrangement can also be made based on the user's intent and the character setting tagging data, personality tagging data, etc., of each AI virtual character to determine which AI virtual character will engage in conversation with the user in each round of conversation. Specifically, the intelligent arrangement may include: analyzing the user's input in the current conversation round to determine their intent, and based on the intent analysis results, the character setting tagging data, personality tagging data of the at least two AI virtual characters, and the contextual information generated during the conversation, matching the at least two AI virtual characters with the user's intent. Based on the matching results, the system determines the target AI virtual character that will converse with the user in the current round of conversation.

In the embodiments of this application, the character data associated with a specific AI virtual character may include not only the aforementioned character setting tagging data and personality tagging data but also exemplary question-and-answer data that reflects the expression habits of the AI virtual character in conversation. When generating response content from the perspective of a particular AI virtual character, this content can be generated based on the character data of the AI virtual character, the user's user data, and the semantic summary information of the conversational context between the AI virtual character and the user. Specifically, using the character data of the AI virtual character, the user data, and the semantic summary information of the conversational context between the AI virtual character and the user, prompt text can be generated for interaction with the AI model. By inputting this prompt text into the AI model, the system can generate conversational content in the tone of the AI virtual character.

In the process where the user customizes an AI virtual character or a user with a creator identity creates an AI virtual character, the embodiments of this application can also assist the user in generating the character data of the AI virtual character through AI generation methods. For example, based on the character setting tagging data and/or personality data of the AI virtual character, AI can generate a plurality of exemplary question data that reflect the expression habits of the AI virtual character in conversation. After the user provides corresponding answer data for the question data, exemplary question-and-answer data reflecting the expression habits of the AI virtual character can be generated. This exemplary question-and-answer data is then used to generate the response content when the corresponding AI virtual character replies.

Alternatively, based on the text-based character data of the AI virtual character, image-based character data can be generated through AI. This image-based character data includes an avatar and/or chat background image.

Additionally, during the specific conversation process, the AI-generated response content from the AI virtual character may include multimodal responses. In this case, before generating the response content from the perspective of the AI virtual character, the type of content to be generated can first be determined. This allows for the use of an AI model with the appropriate content generation capabilities to generate the response content. For example, based on the preceding context in the current chat session, it can be determined what type of modality (such as text or images) would be more appropriate to respond to the user's current input. Afterward, the AI model with the corresponding content generation capability is used to generate the response. Certainly, during the generation of the response content, the character data of the specific AI virtual character is also taken into account, ensuring that the reply is made in the tone of the AI virtual character.

Through the above embodiment, in the AI virtual character-based multi-party conversation mode, during the process where the first AI virtual character is conversing with the user, the AI-generated response content from the perspective of the first AI virtual character can be semantically summarized to extract core keywords. Then, based on the character setting tagging data and/or personality tagging data of other AI virtual characters, it can be determined whether there is a second AI virtual character whose characteristics match the core keywords. If such a character exists, conversational content from the perspective of the second AI virtual character can be generated to agree with the response content of the first AI virtual character. In this way, the multi-party conversation based on AI virtual characters is no longer a series of isolated conversations between the virtual characters and the user. Instead, it enables the virtual characters to “know” each other's conversational content and interact with one another. This enhances the group chat experience, making it closer to a real group chat scenario, thereby improving the user's experience.

Additionally, in the preferred embodiment, during the group chat conversation, intelligent arrangement can be made based on the user's intent and the character setting tagging data and/or personality tagging data of each AI virtual character, to determine which AI virtual character will engage in conversation with the user in each round of conversation. This approach eliminates the random selection of AI virtual characters for user interaction during the group chat, ensuring that the context of the conversation remains more coherent, thereby further enhancing the user experience.

### Embodiment 2

This embodiment addresses the improvements made to the script-based chat mode in the embodiments of this application. It provides an AI virtual character-based script interaction method. Refer to FIG. 3. The method may include:

S301: responding to a user-initiated request for script-based interaction using AI virtual characters, providing a collection of selectable scripts and a collection of selectable AI virtual characters, wherein the scripts are associated with a required number of characters, character setting tagging, and/or personality tagging, allowing the user to select corresponding AI virtual characters from the collection of AI virtual characters; the scripts are further associated with a plurality of key plot segments, and keywords are configured in association with the key plot segments.

S302: after a target script and target AI virtual character are selected, creating a script-based session and adding the user and the target AI virtual character to the session.

S303: during the script-based session, checking the user's input for matches with the keywords, wherein, if a match is found, the plot advances to the next key plot segment associated with the matched keyword; if the user's input does not match with any of the keywords, generating conversational content with the target AI virtual character guiding, based on the keywords, a conversation into the next key plot segment.

In specific implementation, there can be a maximum number of conversation rounds between adjacent key plot segments. If, as the maximum number of conversation rounds approaches, the user's input still does not match the keywords, generate conversational content from the target AI virtual character that uses the keywords to guide the conversation into the next key plot segment.

Certainly, in this embodiment, the basic capabilities mentioned in Embodiment 1 can also be applied, including expressing the character data of virtual characters through additional dimensions of information, supporting the creation process of virtual characters via AI generation, multimodal conversational content generation capabilities, and so on. These aspects are not elaborated further here.

In summary, through the second embodiment of this application, in the “script chat” mode, both the script and characters, as well as the plot, can adopt a weak binding mode. Regarding the plot, key plot segments can be set, and keywords can be configured around these key segments. This allows the user, after a script is selected, to freely choose virtual characters from the character library. During the actual conversation, the system can trigger the transition to the next key plot segment based on whether the user's conversation matches the keywords. If the user's conversation does not match the keywords, the system can generate conversational content from the AI virtual character to guide the plot, encouraging the user to mention the keywords and advancing the plot to the next key segment. This approach enables users to retain a certain level of conversational freedom while still maintaining the characteristic of progressing through the plot in the script-based chat mode, thus enhancing the user experience.

### Embodiment 3

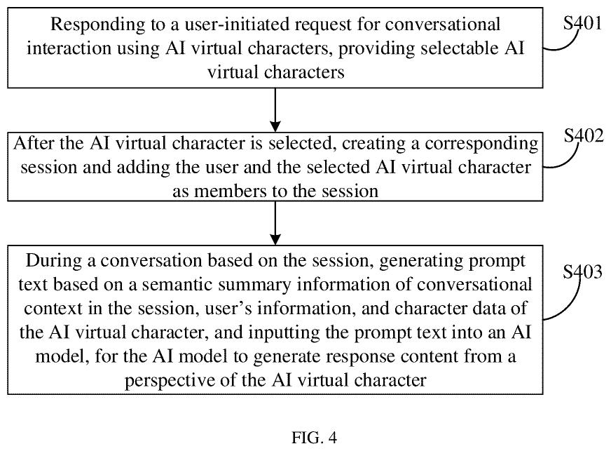

This embodiment mainly addresses the foundational capabilities provided in this application for AI-based chat and presents an AI virtual character-based conversational interaction method. Refer to FIG. 4. The method may include:

S401: responding to a user-initiated request for conversational interaction using AI virtual characters, providing selectable AI virtual characters.

S402: after the AI virtual character is selected, creating a corresponding session and adding the user and the selected AI virtual character as members to the session.

S403: during a conversation based on the session, generating prompt text based on a semantic summary information of conversational context in the session, user's information, and character data of the AI virtual character, and inputting the prompt text into an AI model, for the AI model to generate response content from a perspective of the AI virtual character. The character data of the target AI virtual character includes: character setting tagging data, personality tagging data, and exemplary question-and-answer data that reflects the expression habits of the AI virtual character in conversation. The character setting tagging data includes: tagging words information used to describe the character setting of the AI virtual character.

In the process where the user customizes an AI virtual character or a user with a creator identity creates an AI virtual character, the embodiments of this application can also assist the user in generating the character data of the AI virtual character through AI generation methods. For example, based on the character setting tagging data and/or personality tagging data of the AI virtual character, AI can generate a plurality of exemplary question data that reflect the expression habits of the AI virtual character in conversation. After the user provides corresponding answer data for these questions, exemplary question-and-answer data that reflects the expression habits of the AI virtual character in conversation can be generated. This exemplary question-and-answer data is used to generate the response content when the corresponding AI virtual character replies.

Additionally, during the specific conversation process, the AI-generated response content from the AI virtual character may include multimodal responses. In this case, before generating the response content from the perspective of the AI virtual character, the type of content to be generated can first be determined. This ensures that the appropriate AI model with the corresponding content generation capability is used to generate the response. For example, based on the context in the current chat session, it can be determined what type of modality (such as text or images) would be most suitable for responding to the user's current input. Afterward, the AI model with the corresponding content generation capability is used to generate the response. Certainly, during the generation of the response content, the character data of the specific AI virtual character is also taken into account to ensure the reply is in the tone of the AI virtual character.

Through the third embodiment of this application, by adding the dimension of exemplary question-and-answer data to the character data of the AI virtual character, this exemplary question-and-answer data can reflect the expression habits of the AI virtual character during the conversational process, such as whether the character uses certain catchphrases, and so on. As a result, the AI virtual character can be depicted in a fuller, more three-dimensional, and vivid manner. Specifically, during the conversation with the user, the generated conversational content becomes richer, providing the user with an experience that is closer to interacting with a real person.

Additionally, the generated conversational content is not limited to text but can also include voice, images, videos, and other multimodal forms of conversational content. This makes the conversation more diverse and further enhances the replication of a real-life interaction scenario with a person.

For the parts of Embodiments 1 to 3 that have not been elaborated upon, please refer to other sections of this specification for further details, which will not be repeated here.

It should be noted that the embodiments of this application may involve the use of user data. In practical applications, user-specific personal data can be used within the scope allowed by applicable laws and regulations, provided that the applicable legal requirements are met (e.g., obtaining explicit user consent, notifying users appropriately, etc.), and only in accordance with the permissions granted under the applicable laws and regulations.

Corresponding to Embodiment 1, this application also provides a conversational interaction device based on artificial intelligence (AI) virtual characters. The device may include:
selectable virtual character providing unit: responding to a user's request to initiate a multi-party conversation using AI virtual characters by providing selectable AI virtual characters;
multi-party conversation creation unit: This unit creates a multi-party conversation after at least two AI virtual characters are selected and adds the user and the selected AI virtual characters as members to the conversation;
core keyword extraction unit: semantically summarizing the AI-generated response content from the perspective of the first AI virtual character during the conversation between the first AI virtual character and the user, extracting core keywords;
conversational content generation unit: determining whether there is a second AI virtual character whose characteristics match the core keywords based on the character setting tagging data and/or personality tagging data of other AI virtual characters. If such a character exists, it generates conversational content from the perspective of the second AI virtual character that echoes the response content of the first AI virtual character. The character setting tagging data includes: tagging words information used to describe the character setting of the AI virtual character.

In specific implementation, the device may also include:
intelligent arrangement unit: intelligently arranging the AI virtual characters during the multi-party conversation based on the user's intent and the character setting tagging data and/or personality tagging data of each AI virtual character, to determine which AI virtual character will engage in conversation with the user in each round of conversation;
intelligent arrangement details: the intelligent arrangement including: analyzing the intent of the user's input in the current round of conversation, and based on the intent analysis results, the character setting tagging data and/or personality tagging data of the at least two AI virtual characters, as well as the contextual information generated during the conversation, matching the at least two AI virtual characters with the user's intent; based on the matching results, the system determines the target AI virtual character to engage in the conversation with the user in the current round of conversation.

The character data associated with the AI virtual character includes the character setting tagging data and/or personality tagging data, as well as exemplary question-and-answer data that reflects the expression habits of the AI virtual character in conversation;
when generating response content from the perspective of a specific AI virtual character, the response is generated based on the character data of the AI virtual character, the user's user data, and the semantic summary information of the conversational context between the AI virtual character and the user.

Specifically, the selectable AI virtual characters include system-predefined AI virtual characters, user-customized AI virtual characters, and/or AI virtual characters created by users with creator identities within the system.

Additionally, the device may also include:
character data generation unit: assisting the user in generating the AI virtual character's character data through AI generation methods during the process of user customization of the AI virtual character or the creation of the AI virtual character by a user with a creator identity.

The character data generation unit can specifically be used to:
based on the AI virtual character's character setting tagging data and/or personality tagging data, generate a plurality of exemplary question data through AI generation methods. These questions are designed to reflect the expression habits of the AI virtual character in conversation. After the user provides corresponding answer data for these questions, exemplary question-and-answer data reflecting the expression habits of the AI virtual character in conversation can be generated. This exemplary question-and-answer data is then used to generate the response content when the corresponding AI virtual character replies.

Alternatively, the character data generation unit can specifically be used to:
based on the text-based character data of the AI virtual character, generate image-based character data through AI generation methods. This image-based character data includes an avatar and/or chat background image.

Specifically, the AI-generated response content from the AI virtual character includes multimodal responses. Before generating the response content from the perspective of the AI virtual character, the type of content to be generated is determined. This ensures that the response content is generated by invoking an AI model with the corresponding content generation capabilities.

Corresponding to Embodiment 2, this application also provides an AI virtual character-based conversational interaction device. The device may include:
request receiving unit: responding to a user's request to initiate script-based interaction using AI virtual characters by providing a selectable script collection and a selectable AI virtual character collection. The script is associated with the required number of characters, character setting tagging, and/or personality tagging, allowing the user to select the corresponding AI virtual characters from the AI virtual character collection; the script is also associated with a plurality of key plot segments, and a plurality of keywords are configured around these key plot segments;
conversation creation unit: creating a script-based conversation after the target script and target AI virtual characters are selected, adding the user and the selected AI virtual characters to the conversation;
dialogue content generation unit: in the script-based conversation, checking for matches between the user's input and the keywords; if a match is found, the plot advances to the next key plot segment; if the user's input does not match the keywords, it generates conversational content from the target AI virtual character that uses the keywords to guide the conversation into the next key plot segment.

Specifically, there is a maximum number of conversation rounds between adjacent key plot segments. If, as the maximum number of conversation rounds approaches, the user's input does not match the keywords, the system generates conversational content from the target AI virtual character that uses the keywords to guide the conversation into the next key plot segment.

Corresponding to Embodiment 3, this application also provides an AI virtual character-based conversational interaction device. The device may include:
request receiving unit: responding to a user's request to initiate a conversational interaction using AI virtual characters by providing selectable AI virtual characters;
conversation creation unit: creating the corresponding conversation after the AI virtual character is selected and adds the user and the selected AI virtual character as members to the conversation;
response content generation unit: generating prompt text based on the semantic summary information of the conversational context in the session, the user's information, and the character data of the AI virtual character during the conversation; the prompt text is then input into the AI model to generate response content from the perspective of the AI virtual character; the character data of the target AI virtual character includes: the character setting tagging data, personality tagging data, and exemplary question-and-answer data that reflects the expression habits of the AI virtual character in conversation. The character setting tagging data includes: tagging words information used to describe the character setting of the AI virtual character.

The AI-generated response content from the AI virtual character includes multimodal response content;
before generating the response content from the perspective of the AI virtual character, the type of content to be generated is determined to ensure that the appropriate AI model with the corresponding content generation capabilities is used for generating the response content.

Additionally, the embodiments of this application also provide a computer-readable storage medium, storing a computer program. When executed by a processor, the program performs the steps of any of the methods described in the previous embodiments.

And an electronic device, comprising:
one or more processors; and
a memory associated with the one or more processors, the memory storing program instructions that, when read and executed by the one or more processors, perform the steps of any of the methods described in the previous embodiments.

A computer program product, comprising a computer program/computer-executable instructions, wherein the computer program/computer-executable instructions, when executed by a processor in an electronic device, perform the steps of the method described in the previous embodiments.

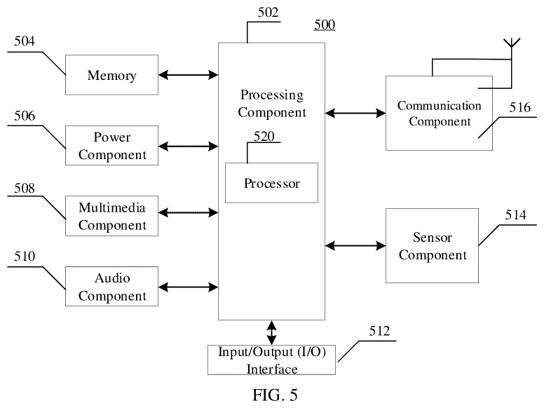

FIG. 5 exemplifies the architecture of the electronic device. For example, device 500 can be a mobile phone, computer, digital broadcast terminal, messaging device, game console, tablet device, medical device, fitness equipment, personal digital assistant, aircraft, and so on.

Referring to FIG. 5, device 500 may include one or more of the following components: processing component 502, memory 504, power component 506, multimedia component 508, audio component 510, input/output (I/O) interface 512, sensor component 514, and communication component 516.

The processing component 502 typically controls the overall operation of device 500, such as operations related to display, phone calls, data communication, camera operations, and recording operations. The processing component 502 may include one or more processors 520 that execute instructions to perform all or part of the steps of the methods provided by the disclosed technical solutions. Additionally, the processing component 502 may include one or more modules to facilitate interaction between the processing component 502 and other components. For example, the processing component 502 may include a multimedia module to facilitate interaction between the multimedia component 508 and the processing component 502.

The memory 504 is configured to store various types of data to support the operation of device 500. Examples of such data include instructions for any applications or methods operating on device 500, contact data, phonebook data, messages, images, videos, etc. The memory 504 can be implemented using any type of volatile or non-volatile storage device, or combinations thereof, such as Static Random Access Memory (SRAM), Electrically Erasable Programmable Read-Only Memory (EEPROM), Erasable Programmable Read-Only Memory (EPROM), Programmable Read-Only Memory (PROM), Read-Only Memory (ROM), magnetic storage, flash memory, disks, or optical discs.

The power component 506 provides power to the various components of device 500. The power component 506 may include a power management system, one or more power sources, and other components associated with generating, managing, and distributing power to device 500.

The multimedia component 508 includes a screen that provides an output interface between device 500 and the user. In some embodiments, the screen may include a Liquid Crystal Display (LCD) and a Touch Panel (TP). If the screen includes a touch panel, it can be implemented as a touchscreen to receive input signals from the user. The touch panel includes one or more touch sensors to sense touches, slides, and gestures on the panel. The touch sensors can not only sense the boundaries of touch or slide actions but also detect the duration and pressure associated with the touch or slide operations. In some embodiments, the multimedia component 508 includes a front-facing camera and/or a rear-facing camera. When device 500 is in operational modes such as capture mode or video mode, the front-facing and/or rear-facing cameras can receive external multimedia data. Each front-facing and rear-facing camera may be a fixed optical lens system or one with focal length and optical zoom capabilities.

The audio component 510 is configured to output and/or input audio signals. For example, the audio component 510 includes a microphone (MIC). When device 500 is in operational modes such as call mode, recording mode, and voice recognition mode, the microphone is configured to receive external audio signals. The received audio signals can be further stored in memory 504 or transmitted via the communication component 516. In some embodiments, the audio component 510 also includes a speaker for outputting audio signals.

The I/O interface 512 provides an interface between the processing component 502 and the peripheral interface modules, which may include a keyboard, click wheel, buttons, and other peripherals. These buttons may include, but are not limited to, the home button, volume button, power button, and lock button.

The sensor component 514 includes one or more sensors that provide various status evaluations for device 500. For example, the sensor component 514 can detect the on/off status of device 500, the relative positioning of components such as the device's display and keypad, and can also detect changes in the position of device 500 or its components, the presence or absence of user contact with device 500, the device's orientation or acceleration/deceleration, and temperature changes in device 500. The sensor component 514 may include a proximity sensor configured to detect the presence of nearby objects without any physical contact. The sensor component 514 may also include an optical sensor, such as a CMOS or CCD image sensor, used in imaging applications. In some embodiments, the sensor component 514 may further include an accelerometer, gyroscope sensor, magnetic sensor, pressure sensor, or temperature sensor.

The communication component 516 is configured to facilitate wired or wireless communication between device 500 and other devices. Device 500 can connect to wireless networks based on communication standards, such as Wi-Fi, or mobile communication networks like 2G, 3G, 4G/LTE, 5G, and so on. In one exemplary embodiment, the communication component 516 receives broadcast signals or broadcast-related information from an external broadcast management system via a broadcast channel. In another exemplary embodiment, the communication component 516 also includes a Near Field Communication (NFC) module to facilitate short-range communication. For example, the NFC module can utilize technologies such as Radio Frequency Identification (RFID), Infrared Data Association (IrDA), Ultra-Wideband (UWB), Bluetooth (BT), and other technologies to implement short-range communication.

In an exemplary embodiment, device 500 can be implemented using one or more Application-Specific Integrated Circuits (ASICs), Digital Signal Processors (DSPs), Digital Signal Processing Devices (DSPDs), Programmable Logic Devices (PLDs), Field-Programmable Gate Arrays (FPGAs), controllers, microcontrollers, microprocessors, or other electronic components, to execute the aforementioned methods.

In an exemplary embodiment, a non-transitory computer-readable storage medium including instructions is also provided, such as memory 504 that contains instructions. These instructions can be executed by the processor 520 of device 500 to complete the methods provided by the disclosed technical solution. For example, the non-transitory computer-readable storage medium can be ROM, Random Access Memory (RAM), CD-ROM, magnetic tape, floppy disks, optical data storage devices, and other types of storage media.

From the description of the above embodiments, those skilled in the art can clearly understand that the technical solutions of this application can be implemented using software combined with the necessary general hardware platform. Based on this understanding, the technical solutions of this application, or the portions of the contribution made to the existing technology, can be embodied in the form of a software product. This computer software product can be stored on a storage medium, such as ROM/RAM, magnetic disks, optical discs, etc., and includes a plurality of instructions that enable a computing device (which can be a personal computer, server, or network device, etc.) to execute the methods described in various embodiments of this application or some parts of the embodiments.

The various embodiments in this specification are described in a progressive manner. Similar or identical parts between the embodiments can be cross-referenced, with each embodiment focusing on the differences from others. Specifically, for system or system embodiments, since they are fundamentally similar to the method embodiments, their descriptions are more concise, and the relevant parts can be referenced from the method embodiments. The systems and system embodiments described above are merely illustrative. The units described as separate components may or may not be physically separated, and components displayed as units may or may not be physical units; they can be located in one place or distributed across a plurality of network units. Depending on actual needs, some or all of the modules can be selected to achieve the objectives of the embodiment. Those skilled in the art can understand and implement the solution without requiring inventive effort.

The above provides a detailed description of the AI virtual character-based conversational interaction method and electronic device offered by this application. Specific examples have been used in this document to explain the principles and implementation methods of this application. The descriptions of the embodiments above are intended to assist in understanding the methods and core ideas of this application. At the same time, for those skilled in the art, there may be variations in the specific implementation methods and applications based on the ideas of this application. Therefore, the content of this specification should not be understood as limiting the scope of this application.

What is claimed is:

1. A conversational interaction method based on artificial intelligence (AI) virtual characters, comprising:
responding to a request initiated by a user to initiate a multi-party conversation session based on the AI virtual characters, providing selectable AI virtual characters;
after at least two AI virtual characters are selected, creating a multi-party conversation session, and adding the user and the at least two AI virtual characters as session members to the multi-party conversation session;
during the conversation between a first AI virtual character of the at least two AI virtual characters and the user, semantically summarizing AI-generated response content from a perspective of the first AI virtual character to extract a core keyword;
based on character setting tagging data and/or personality tagging data of other AI virtual characters, determining whether there is a second AI virtual character in the at least two AI virtual characters who's characteristic matches the core keyword, and if such a character exists, generating conversational content from the perspective of the second AI virtual character that echoes the response content of the first AI virtual character,
wherein the character setting tagging data comprises tagging words information used to describe the character setting of the AI virtual character.

2. The method of claim 1, wherein the method further comprises:
during the multi-party conversation, intelligently arranging the AI virtual characters based on user's intent and the character setting tagging data and/or personality tagging data of each AI virtual character, to determine which AI virtual character will engage in conversation with the user in each round of conversation,
wherein the intelligent arranging comprises: analyzing the intent of the user's input in a current round of conversation, and based on an intent analysis result, the character setting tagging data and/or personality tagging data corresponding to the at least two AI virtual characters, and contextual information generated during the conversation, matching the at least two AI virtual characters with the user's intent, and determining a target AI virtual character to engage in conversation with the user in the current round of conversation based on the matching result.

3. The method of claim 1, wherein:
character data associated with the AI virtual characters comprises the character setting tagging data and/or personality tagging data, and exemplary question-and-answer data that reflects expression habits of the AI virtual characters in conversation,
when generating the response content from the perspective of a specific AI virtual character, the response content is generated based on the character data of the AI virtual character, user data of the user, and semantic summary information of conversational context between the AI virtual character and the user.

4. The method of claim 1, wherein the selectable AI virtual characters comprise a system-predefined AI virtual character, a user-customized AI virtual character, and/or an AI virtual character created by a user with a creator identity within the system.

5. The method of claim 4, wherein the method further comprises:
during a customization of an AI virtual character by a user or a creation of an AI virtual character by a user with a creator identity, assisting the user in generating the character data of the AI virtual character through an AI generation method.

6. The method of claim 5, wherein assisting the user in generating the character data of the AI virtual character through an AI generation method comprises:
based on the character setting tagging data and/or the personality tagging data of the AI virtual character, generating a plurality of exemplary question data through the AI generation method, which reflect expression habits of the AI virtual character in conversation, and generating exemplary question-and-answer data after the user provides corresponding answer data for the question data, the exemplary question-and-answer data reflecting the expression habits of the AI virtual character in conversation, and the exemplary question-and-answer data is used to generate the response content when the corresponding AI virtual character replies.

7. The method of claim 5, wherein assisting the user in generating the character data of the AI virtual character through an AI generation method comprises:
based on text-based character data of the AI virtual character, generating image-based character data through the AI generation method, wherein the image-based character data comprises an avatar and/or chat background image.

8. The method of claim 1, wherein:
the AI-generated response content from the AI virtual character comprises multimodal response content;
before generating the response content from the perspective of the AI virtual character, the method further comprises determining a content type of the response content to be generated, so that the response content is generated by invoking an AI model with the corresponding content generation capability.

9. A non-transitory computer-readable storage medium configured with instructions executable by one or more processors to cause the one or more processors to perform the method of claim 1.

10. An electronic device comprising:
one or more processors; and
one or more computer-readable memories coupled to the one or more processors and having instructions stored thereon that are executable by the one or more processors to perform the method of claim 1.

11. A conversational interaction method based on artificial intelligence (AI) virtual characters, comprising:
responding to a user-initiated request for script-based interaction using AI virtual characters, providing a collection of selectable scripts and a collection of selectable AI virtual characters, wherein each of the scripts is associated with a required number of characters, character setting tagging, and/or personality tagging, allowing the user to select corresponding AI virtual characters from the collection of AI virtual characters, and each of the scripts is further associated with a plurality of key plot segments, and keywords are configured in association with the key plot segments;
after a target script and target AI virtual character are selected, creating a script-based session and adding the user and the target AI virtual character to the session;
during the script-based session, checking the user's input for matches with the keywords, wherein, if a match with any of the keywords is found, advancing to a next key plot segment associated with the matched keyword, and if the user's input does not match with the keywords, generating conversational content with the target AI virtual character guiding, based on the keywords, a conversation into a next key plot segment associated with at least one of the keywords.

12. The method of claim 11, wherein:
there is a maximum number of conversation rounds between adjacent key plot segments, wherein, if, as the maximum number of conversation rounds approaches, the user's input does not match any of the keywords, generating conversational content with the target AI virtual character guiding, based on the keywords, a conversation into a next key plot segment associated with at least one of the keywords.

13. A non-transitory computer-readable storage medium configured with instructions executable by one or more processors to cause the one or more processors to perform the method of claim 11.

14. An electronic device comprising:
one or more processors; and
one or more computer-readable memories coupled to the one or more processors and having instructions stored thereon that are executable by the one or more processors to perform the method of claim 11.

15. A conversational interaction method based on artificial intelligence (AI) virtual characters, comprising:
responding to a user-initiated request for conversational interaction using AI virtual characters, providing selectable AI virtual characters;
after an AI virtual character is selected, creating a corresponding session and adding the user and the selected AI virtual character as members to the session;
during a conversation in the session, generating prompt text based on semantic summary information of conversational context in the session, user's information, and character data of the AI virtual character, and inputting the prompt text into an AI model, for the AI model to generate response content from a perspective of the AI virtual character,
wherein the character data of an AI virtual character comprises: character setting tagging data, personality tagging data, and exemplary question-and-answer data that reflects expression habits of the AI virtual character in conversation, and the character setting tagging data comprises:
tagging words information used to describe the character setting of the AI virtual character.

16. The method of claim 15, wherein:
the response content from a perspective of the AI virtual character comprises multimodal response content;
the method further comprises: determining a type of response content to be generated, and inputting the prompt text into an AI model comprises inputting the prompt text into an AI model with corresponding capability to generate the type of response content.

17. A non-transitory computer-readable storage medium configured with instructions executable by one or more processors to cause the one or more processors to perform the method of claim 15.

18. An electronic device comprising:
one or more processors; and
one or more computer-readable memories coupled to the one or more processors and having instructions stored thereon that are executable by the one or more processors to perform the method of claim 15.
